(19) United States
(12) Patent Application Publication
(10) Pub. No.: US 2009/0267860 A1
(43) Pub. Date: Oct. 29, 2009

(54) Antenna fixed device with adjustable function

(76) Inventor: Kai-Tien Peng, Science Park (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,619

(22) Filed: Aug. 13, 2008

(30) Foreign Application Priority Data
Apr. 24, 2008 (TW) 097114997

(51) Int. Cl. H01Q 1/12

(52) U.S. Cl. 343/878

(57) ABSTRACT

An antenna fixed device with adjustable function is provided, comprising a carrier, a connection part, and a base, wherein the carrier is used for carrying the antenna and further connecting with the connection part, the connection part comprises an extension unit and a first locking hole, which is provided on the extension unit, the base comprises a container, which is used for containing the extension unit. Since a first locking unit is used to pierce through the first locking hole of the extension unit and the groove of the base, the antenna provided on the carrier can be adjustable for direction according to the connection of the carrier, the connection part, and the base.

### BACKGROUND OF THE INVENTION

1. Technical Field

The present invention is related to an antenna fixed device, more particularly to an antenna fixed device with adjustable function having the connection of the carrier, the connection part, and the base for being direction adjustable.

2. Description of the Prior Art

Since technology is going progress unceasingly, the wireless communication device is accordingly applied around every field of our life little by little, however, according to the antenna, such as panel antenna or dish antenna, it should be adjusted its angle or aspect depending on the direction of signal transmission for having more obvious signal.

Practically, the antenna is provided on a fixture, the mechanism of which can be used for adjusting the angle or aspect of the antenna. Referring to Taiwan Patent Publication no. 416579, it discloses a dish antenna that is provided on a supporter, in detail, the supporter comprises a revolvable set and a vertical worm shaft, thereby, the dish antenna can be adjusted at horizontal direction and vertical direction accordingly.

For the limitation of the supporter, the dish antenna can be simply adjusted for rising or descending at the vertical direction, and cannot be adjusted on the angle along the vertical direction, thus, the dead space would be had easily while the dish antenna is adjusted.

The supporter is used with adjustable function according to the gear therein revolves to drive the dish antenna toward the desired aspect since the gear is wedged with the corresponding element, however, the supporter would be failure with respect to the adjustment thereof is unstable since the outdoor environment where the supporter is located would experience the sunshine or the battering by the wind and the rain.

### SUMMARY OF THE INVENTION

It is therefore a primary object of the present invention to provide an antenna fixed device with adjustable function, which comprises a carrier, a connection part, and a base, thereby, the antenna provided on the carrier can be adjustable on omni-directional aspect according to the connection of the carrier, the connection part, and the base.

It is a secondary object of the present invention to provide an antenna fixed device with adjustable function, the base of which comprises a groove where the connection part of the device can move along, thereby, the antenna can be adjusted for the desired angle along the vertical direction.

It is another object of the present invention to provide an antenna fixed device with adjustable function, the carrier of which can be used for the adjustment since the antenna can be adjusted for the desired angle along the horizontal direction.

It is still another object of the present invention to provide an antenna fixed device with adjustable function, the base of which comprises a container for containing the extension unit of the connection part, thereby, the structure of the base can be used for carrying the weight of the antenna and the carrier.

It is still another object of the present invention to provide an antenna fixed device with adjustable function, wherein the base comprises a protrudent edge, the connection part comprises at least one positioning groove, thereby, the angle between the connection part and the base can be fixed advantageously.

It is still another object of the present invention to provide an antenna fixed device with adjustable function, wherein a cylinder can be clipped by the base and the pedestal, thereby, the antenna can be adjusted for the desired angle along the horizontal direction.

It is still another object of the present invention to provide an antenna fixed device with adjustable function, wherein the carrier can be used for adjustment since the antenna can be adjusted for the desired angle along the vertical direction.

According to the above objects, an antenna fixed device with adjustable function is provided, comprising a carrier for carrying an antenna; a connection part connecting to the carrier, comprising an extension unit, wherein a first locking hole is provided on the extension unit; and a base, comprising a container for containing the extension unit, the container comprises a groove, wherein a first locking unit pierces through the first locking hole and the groove.

According to the above objects, another antenna fixed device with adjustable function is provided, comprising a carrier for carrying an antenna, comprising an extension unit, wherein a locking hole is provided on the extension unit; and a clipper, comprising a base and a pedestal, wherein the base comprises a container for containing the extension unit, the container comprises a groove, wherein a first locking unit pierces through the locking hole and the groove.

The present invention can be best understood through the following description and accompanying drawings.

### BRIEF DESCRIPTION OF THE DRAWINGS

FIG. 1 is a block diagram of the structure of the antenna fixed device with adjustable function according to a preferred embodiment of the present invention;

FIG. 2A to FIG. 2C are block diagrams showing the application status of the antenna fixed device with adjustable function according to the preferred embodiment of the present invention;

FIG. 3 is a block diagram of the structure of the antenna fixed device with adjustable function according to another preferred embodiment of the present invention; and

FIG. 4A to FIG. 4C are block diagrams showing the application status of the antenna fixed device with adjustable function according to the preferred embodiment of the present invention;

### DETAILED DESCRIPTION OF THE PREFERRED EMBODIMENTS

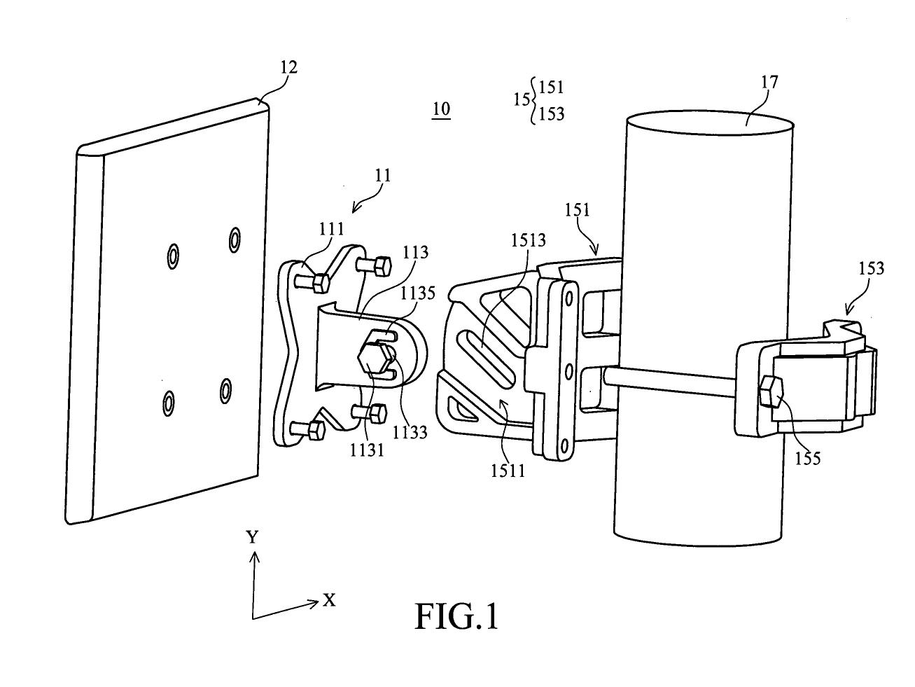

Referring to FIG. 1, a block diagram of the structure of the antenna fixed device with adjustable function according to a preferred embodiment of the present invention is disclosed. The antenna fixed device 10 comprises a carrier 11 and a clipper 15, wherein the carrier 11 is connected to an antenna 12, used for carrying the weight of the antenna 12, and the clipper 15 is connected to the carrier 11, used for clipping a cylinder 17, thereby, the antenna 12 can be provided on the cylinder 17 accordingly.

The carrier 11 comprises a carrying board 111 and an extension unit 113, wherein the carrying board 111 is used for carrying the antenna 12. The carrying board 111 comprises a plurality of holes, and the antenna 12 comprises the corresponding screw-holes. The antenna 12 and the carrying board 111 are connected according to the screw aims at the holes and the corresponding screw-holes and pierce through.

The clipper 15 comprises a base 15 and a pedestal 153, both of which are connected by the connection of a plurality of locking units 155. The base 151 comprises a plurality of screw-holes, and the pedestal 153 comprises the corresponding holes. The pedestal 153 can be fixed on the base 151 according to the locking unit 155, such as the screw, aims at the screw-holes and the corresponding holes, and pierce through. Thereby, the base 151 and the pedestal 153 can clip a cylinder 17 according to the application of the base 151, the pedestal 153, and the locking units 155.

The base 151 comprises a container 1511 and a groove 1513, wherein the groove 1513 is provided within the container 1511. The container 1511 is used for containing and wedging the extension unit 113, therefore, the base 151 can carry the weight of the antenna 12 and the carrier 11 stably.

A first locking unit 1131, such as the nut and bolt, is used for connecting the carrier 11 and the base 151. The extension unit 113 provided on the carrier 11 comprises a locking hole 1133. Therefore, the carrier 11 and the clipper 15 can be connected according to the first locking unit 1131 pierces through the locking hole 1133 and the groove 1513. Since the shape of the groove 1513 is like a bar, the carrier 11 can move along the groove 1513 and the container 1511 while the first locking unit 1131 has been loosed for adjustment, thereafter, the first locking unit 1131 can be fastened while the angle adjustment of antenna 12 is finished.

A limitation unit 1135 is provided around the peripheral of the locking hole 1133 or the partial peripheral of the locking hole 1133, wherein the limitation 1135 is used for limiting the revolving of the first locking unit 1131 for conveniently locking the carrier 11 and the clipper 15 by the first locking unit 1131.

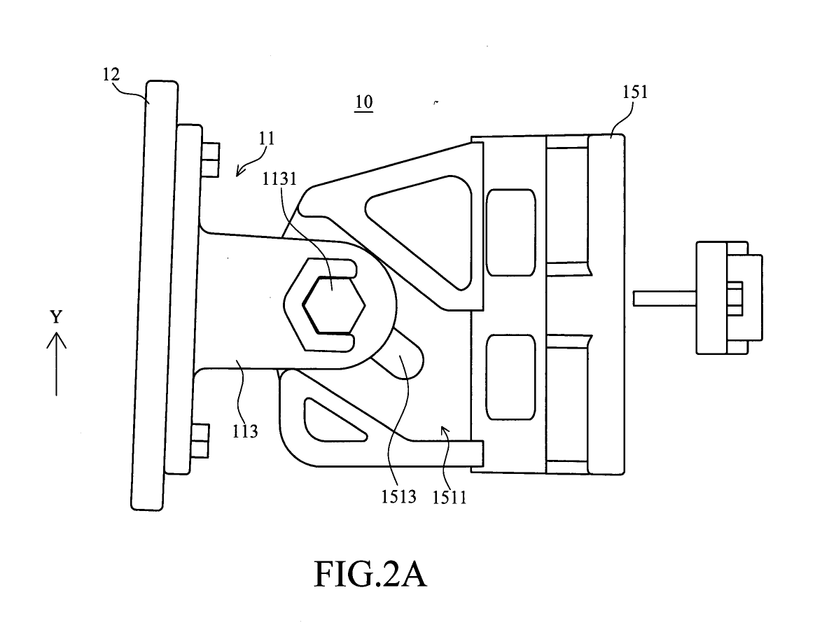

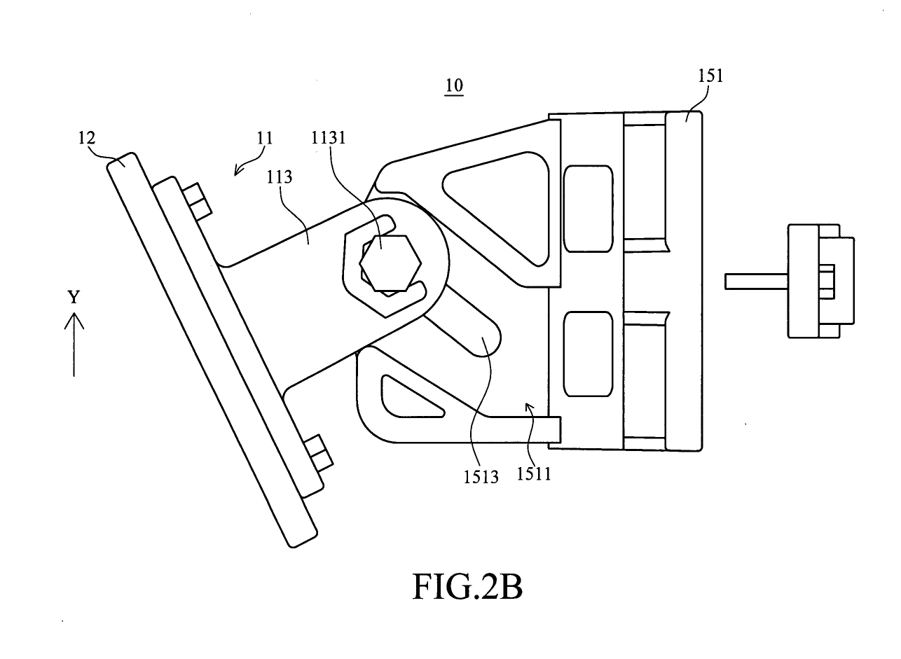

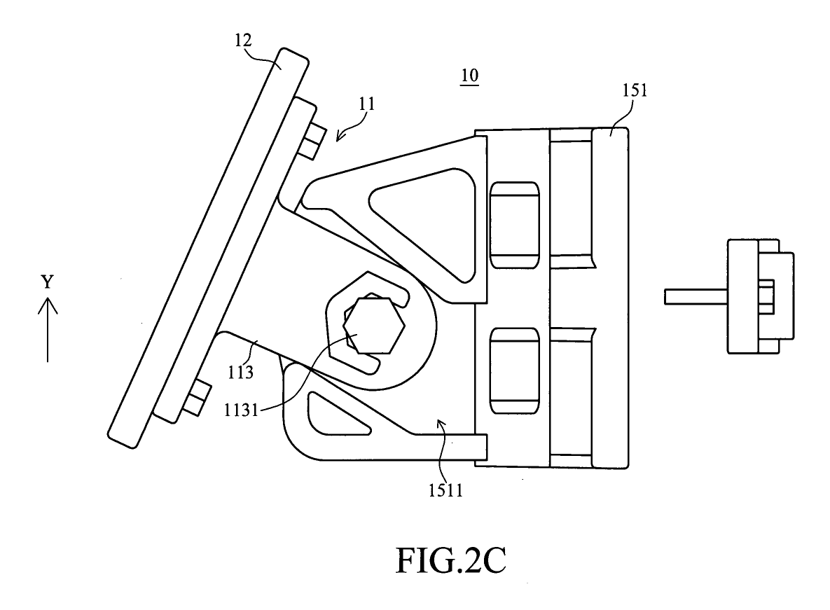

The clipper 15 is used for clipping the cylinder 17 by the base 151 and the pedestal 153. The clipper 15 can move opposite the cylinder 17 while the locking unit 155 provided between the base 151 and the pedestal 153 has been fastened. The clipper 15 can revolve opposite the cylinder 17 on the first direction X, such as the horizontal direction, for adjusting the angle of the antenna 12 on the first direction X. Furthermore, the clipper 15 can be used for adjusting the height of the antenna 12 along the cylinder 17, and the carrier 11 can move opposite the clipper 15 on the second direction Y, such as the vertical direction. The first direction X and the second direction Y are orthogonal, referring to the following description of FIG. 2A to FIG. 2C.

Referring to FIG. 2A to 2C, block diagrams showing the application status of the antenna fixed device with adjustable function according to the preferred embodiment of the present invention are disclosed. The first locking unit 1131 is used for connecting the carrier 11 and the base 151. The first locking unit 1131 pierces through the locking hole 1133 of the extension unit 113 and the groove 1513 of the base 151, and limits the moving field of the extension unit 113 within the container 1511, thereby, the structure of the base 151 can carry the weight of the antenna 12 and the carrier 11 advantageously.

According to the present invention, the antenna 12 is provided on the antenna fixed device 10, and the antenna fixed device 10 can be used for adjusting the angle and the aspect of the antenna 12. Referring to the embodiment described on FIG. 1, the clipper 15 of the antenna fixed device 10 can revolve along the cylinder 17 for adjusting the angle of the antenna 12 on the first direction X. Continuously, the following description further discloses that the angle of the antenna 12 can be adjusted on the second direction Y since the carrier 11 and the base 151 are connection.

Practically, the antenna 12 can be adjusted to be horizontal level by the antenna fixed device 10 according to the demand, as shown on FIG. 2A. The part of extension unit 113 is provided within the container 1511 of the base 151, and it can be integrated with the base 151 by the first locking unit 1131, such that the weight of the antenna 12 and the carrier 11 can be spread around the first locking unit 1131, the groove 1513, and the container 1511 evenly, thereby, the antenna 12 and the carrier 11 can be provided on the base 151 stably.

Certainly, the angle of the antenna 12 can be adjusted to be upward or downward by the antenna fixed device 10. Referring to FIG. 2B, the angle of the antenna 12 is adjusted to be downward by the antenna fixed device 10, as well as, referring to FIG. 2C, the angle of the antenna 12 is adjusted to be upward by the antenna fixed device 10. Therefore, the angle of the antenna 12 can be adjusted on the second direction Y, such as vertical direction, furthermore, the first direction X and the second direction Y are orthogonal, thereby, the angle the antenna 12 can be adjusted on any direction accordingly.

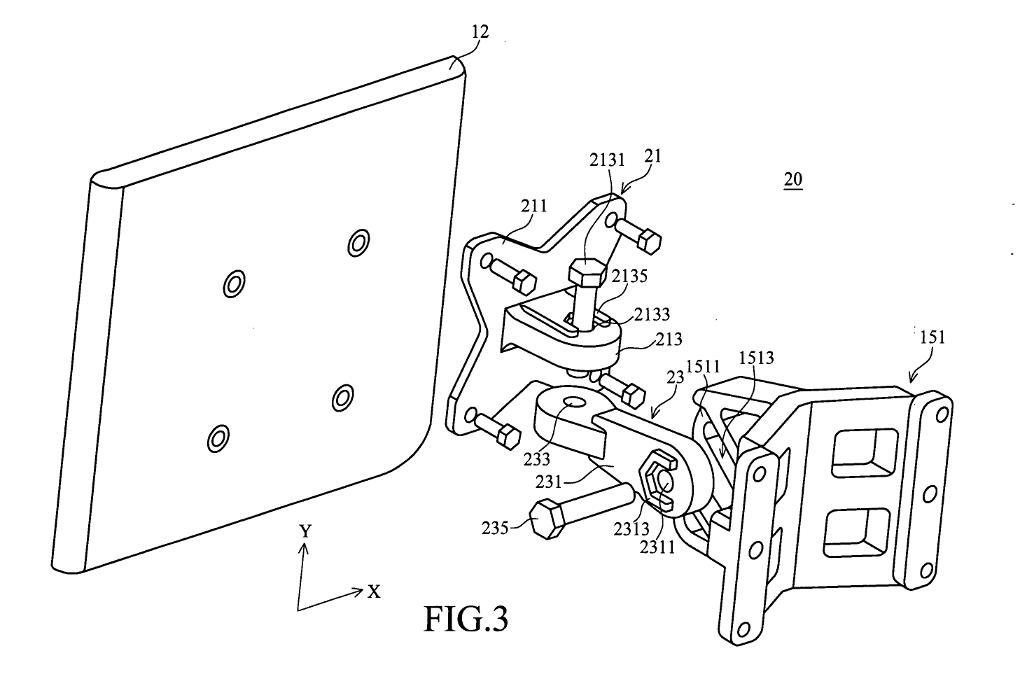

Referring to FIG. 3, a block diagram of the structure of the antenna fixed device with adjustable function according to another preferred embodiment of the present invention is disclosed. The antenna fixed device 20 comprises a carrier 21, a connection part 23, and a base 151, wherein the carrier 21 is used for carrying the antenna 12, and connected to the base through the connection part 23. The angle and aspect of the antenna 12 can be adjusted on the first direction X and the second direction Y according to the opposite movement between the carrier 21, the connection part 23, and the base 151.

The carrier 21 comprises a carrying board 211 and a joint unit 213, wherein the carrying board 211 is used for carrying the antenna 12. The carrying board 211 comprises a plurality of holes, and the antenna 12 comprises the corresponding screw-holes, thereby, the antenna 12 and the carrying board 211 can be connected according to the screw aims at the holes and the corresponding screw-holes and pierce through.

The connection part 23 is used for connecting the carrier 21 and the base 151, and it comprises an extension unit 231. The extension unit 231 is provided within the container 1511 of the base 151. A first locking unit 235, such as the nut and bolt, is used for connecting the connection part 23 and the base 151. The extension unit 231 comprises a first locking hole 2311, and the container 1511 comprises a groove 1513, therefore, the first locking unit 235 can pierce through the first locking hole 2311 and the groove 1513 for having the connection of the connection part 23 and the base 151.

The connection part 23 can move along the groove 1513 and the container 1511 after the first locking unit 235 has been loosed for adjustment, continuously, while the angle of the antenna 12 has been adjusted accurately, the first locking unit 235 can be fastened, thus, the angle of the antenna 12 is adjusted.

The joint unit 213 comprises a second locking hole 2133, and the connection part 23 comprises the corresponding third locking hole 233. A second locking unit 2131, such as the nut and bolt, is used for connecting the carrier 21 and the connection part 23 since the second locking unit 2131 aims at the second locking hole 2133 and the third locking hole 233 and pierces through. The carrier 21 can move opposite the connection part 12 after the second locking unit 2131 has been loosed for adjustment, further, while the angle of the antenna 12 has been adjusted accurately, the second locking unit 2131 can be fastened, thus, the angle of the antenna 12 is adjusted.

For more convenience with respect to the first locking unit 231 and the second locking unit 2131 are provided, a first limitation unit 2313 is provided around the peripheral or the partial peripheral of the first locking hole 2311, and a second limitation unit 2135 is provided around the peripheral or the partial peripheral of the second locking hole 2133 and/or the third locking hole 233.

The carrier 21 and the connection part 23 can move oppositely on the first direction X, such as the horizontal direction, and further drive the antenna 12 to revolve on the first direction X. The connection part 23 can move along the container 1511 and the groove 1513 on the second direction Y, such as the vertical direction, that is opposite to the base 151, and further drive the antenna 12 to be adjusted the angle and the aspect thereof on the second direction Y, wherein the shape of the groove 1513 is like a bar, and the first direction X and the second direction Y are orthogonal, therefore, the antenna 12 can be adjusted by the antenna fixed device 20.

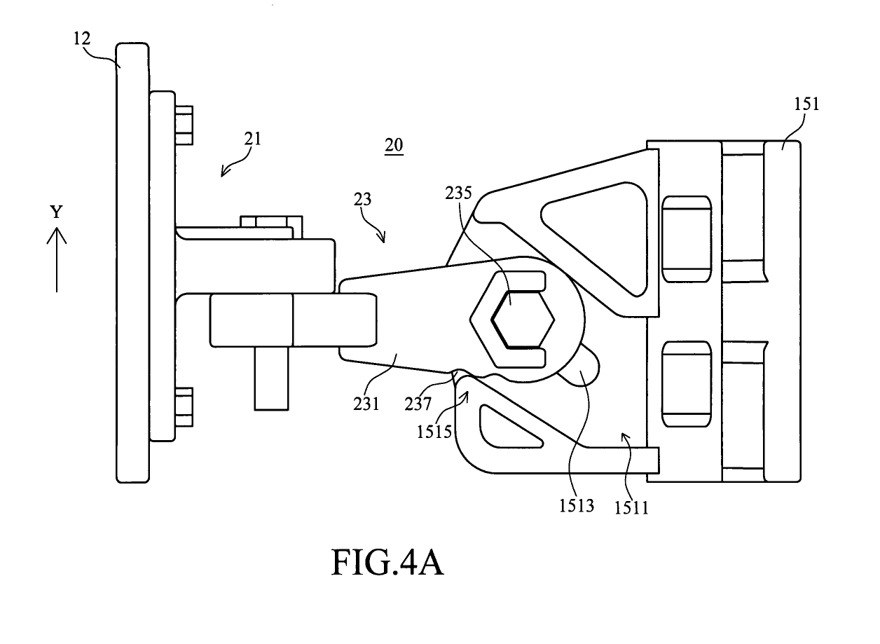

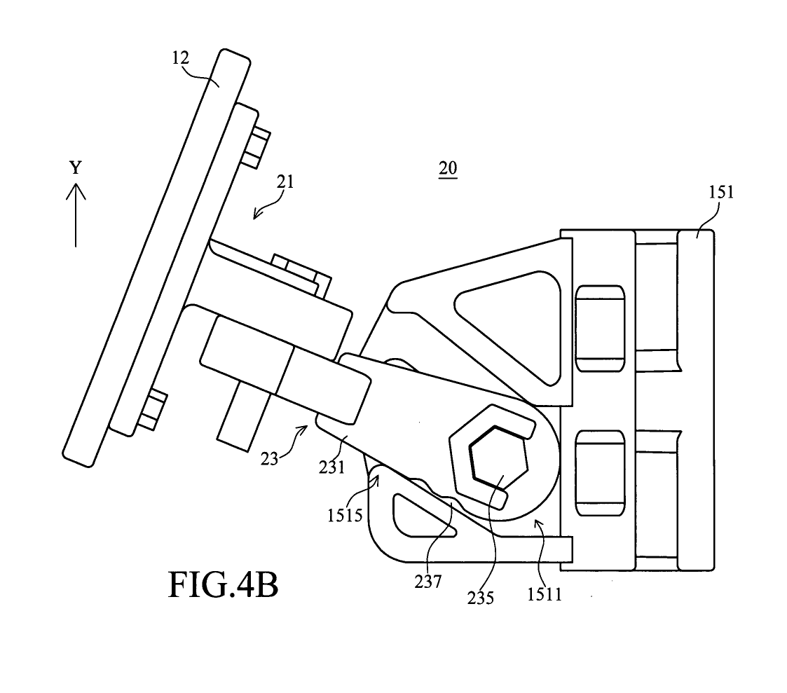

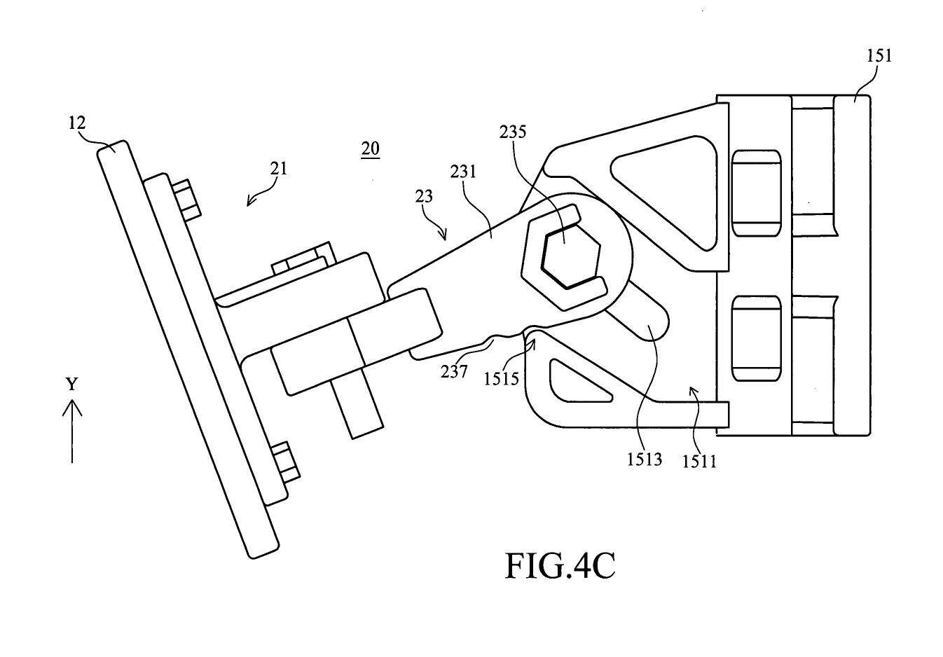

Referring to FIG. 4A to FIG. 4C, block diagrams showing the application status of the antenna fixed device with adjustable function according to the preferred embodiment of the present invention are disclosed. The carrier 21 is connected to the base 151 through the connection part 23, therefore, the carrier 21 can move opposite the connection part 23 on the first direction X, and the connection part 23 can move opposite the base 151 on the second direction Y, thereby, the antenna 12 can be adjusted on any angle and aspect thereof.

Continuously, the following description further discloses that the angle of the antenna 12 can be adjusted on the second direction Y since the carrier 11, the connection part 23, and the base 151 are connection. The antenna 12 can be adjusted to be horizontal level by the antenna fixed device 20, as shown on FIG. 4A. The part of extension unit 231 is provided within the container 1511 of the base 151, and it can be integrated with the base 151 by the first locking unit 235, such that the weight of the antenna 12, the carrier 21, and the connection part 23 can be spread around the first locking unit 235, the groove 1513, and the container 1511 evenly.

Certainly, the angle of the antenna 12 can be adjusted to be upward or downward by the antenna fixed device 20, referring to FIG. 4B and FIG. 4C. Furthermore, the extension unit 231 comprises at least one positioning groove 237, and the base 151 comprises the corresponding protrudent edge 1515, thereby, the protrudent edge 1515 can be wedged in any positioning groove 237 for preventing from abnormal slide while the connection part 23 and the base 151 are adjusting the angle between both. As well as, the protrudent edge 1515 and the positioning groove 237 can be applied on the embodiment of FIG. 1 surely.

The above embodiments are only used to illustrate the present invention, not intended to limit the scope thereof. Many modifications of the above embodiments can be made without departing from the spirit of the present invention.

What is claimed is:

1. An antenna fixed device with adjustable function, comprising:
a carrier for carrying an antenna, comprising an extension unit, wherein a locking hole is provided on said extension unit; and
a clipper, comprising a base and a pedestal, wherein said base comprises a container for containing said extension unit, and said container comprises a groove, wherein a first locking unit pierces through said locking hole and said groove.

2. The antenna fixed device of claim 1, comprising a limitation unit provided around the peripheral of said locking hole or partial peripheral of said locking hole.

3. The antenna fixed device of claim 1, wherein said base and said pedestal are integrated by a plurality of locking units.

4. The antenna fixed device of claim 3, wherein said base and said pedestal can be used for clipping a cylinder.

5. The antenna fixed device of claim 4, wherein said clipper revolves on the first direction that is opposite to said cylinder, and said carrier and said clipper move oppositely along the second direction, wherein said first direction and said second direction are orthogonal.

6. The antenna fixed device of claim 1, wherein said carrier comprises a carrying board that is connected to said antenna.

7. The antenna fixed device of claim 1, wherein the shape of said groove provided on said base is like a bar.

8. The antenna fixed device of claim 1, wherein said extension unit comprises at least one positioning groove, and said base comprises a protrudent edge.

9. An antenna fixed device with adjustable function, comprising:
a carrier for carrying an antenna;
a connection part connecting to said carrier, comprising an extension unit, wherein a first locking hole is provided on said extension unit; and
a base, comprising a container for containing said extension unit, said container comprises a groove, wherein a first locking unit pierces through said first locking hole and said groove.

10. The antenna fixed device of claim 9, comprising a first limitation unit provided around the peripheral of said first locking hole or partial peripheral of said first locking hole.

11. The antenna fixed device of claim 9, wherein said carrier comprises a second locking hole, and said connection part comprises a third locking hole, wherein a second locking unit pierces through said second locking hole and said third locking hole for having the connection of said carrier and said connection part.

12. The antenna fixed device of claim 11, comprising a second limitation unit provided around the peripheral of said second locking hole, partial peripheral of said second locking hole, the peripheral of said third locking hole, or partial peripheral of said third locking hole.

13. The antenna fixed device of claim 9, wherein the shape of said groove provided on said base is like a bar.

14. The antenna fixed device of claim 9, wherein said extension unit comprises at least one positioning groove, and said base comprises a protrudent edge.

15. The antenna fixed device of claim 9, comprising a pedestal integrating with said base.

16. The antenna fixed device of claim 9, wherein said carrier and said connection part move oppositely along the first direction, and said connection part and said base move oppositely along the second direction, wherein said first direction and said second direction are orthogonal.

17. The antenna fixed device of claim 9, wherein said carrier comprises a carrying board that is connected to said antenna.
